(19) United States
(12) Patent Application Publication
(10) Pub. No.: US 2009/0150803 A1
(43) Pub. Date: Jun. 11, 2009

(54) INSTANT MESSAGING INTERFACE HAVING MULTIPLE RESPONSE WINDOWS

(76) Inventor: Alexander S. Ross, Toronto (CA)

Correspondence Address: HOFFMAN WARNICK LLC, 75 STATE ST, 14 FL, ALBANY, NY, 12207, US

(21) Appl. No.: 11/950,626

(22) Filed: Dec. 5, 2007

(51) Int. Cl. G06F 3/048

(52) U.S. Cl. 715/758

(57) ABSTRACT

The present invention is directed to an instant messaging interface having multiple response windows. An instant messaging (IM) interface in accordance with an embodiment of the present invention includes: a chat window for displaying a chat between a plurality of IM users; a current response window for displaying response data for inclusion in the chat; a next response window; and a move element for: clearing the response data displayed in the current response window and sending the response data to, and displaying the response data in, the next response window; and sending the response data displayed in the next response window back to the current response window.

### BACKGROUND OF THE INVENTION

1. Field of the Invention

The present invention generally relates to instant messaging. More specifically, the present invention is directed to an instant messaging interface having multiple response windows.

2. Related Art

In instant messaging systems, a user may be typing a message, and then receive a response from the person with whom the user is corresponding, which may cause the user to want to respond differently, without deleting the response the user was already typing. For example, a user may have been typing a question Q1 when the other person asks the user a question Q2. In this case, the user may wish to respond to the question Q2 before communicating their own question Q1 to the other person.

One solution for addressing this dilemma is to use the “cut and paste” feature found in many computer operating systems. For example, a user can “cut” and save (e.g., on a “clipboard”) a response the user is currently typing, and then type a new response. Then, the user can retrieve the saved response using “paste” once the new response has been sent. This can be cumbersome, and can result in errors if a user fails to highlight the entire response they were working on.

### SUMMARY OF THE INVENTION

The present invention is directed to an instant messaging interface having multiple response windows.

A first aspect of the invention is directed to an instant messaging (IM) interface, comprising: a chat window for displaying a chat between a plurality of IM users; a current response window for displaying response data for inclusion in the chat; a next response window; and a move element for: clearing the response data displayed in the current response window and sending the response data to, and displaying the response data in, the next response window; and sending the response data displayed in the next response window back to the current response window.

Another aspect of the present invention is directed to a method for instant messaging, comprising: providing an instant messaging (IM) interface comprising a chat window for displaying a chat between a plurality of IM users, a current response window for displaying response data for inclusion in the chat, a next response window, and a move element; actuating the move element to clear the response data displayed in the current response window and to send the response data to, and display the response data in, the next response window; and actuating the move element to send the response data displayed in the next response window back to the current response window.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative instant messaging interface with multiple windows in accordance with an embodiment(s) of the present invention.

FIG. 2 depicts an illustrative environment for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As described above, the present invention is directed to an instant messaging interface having multiple response windows.

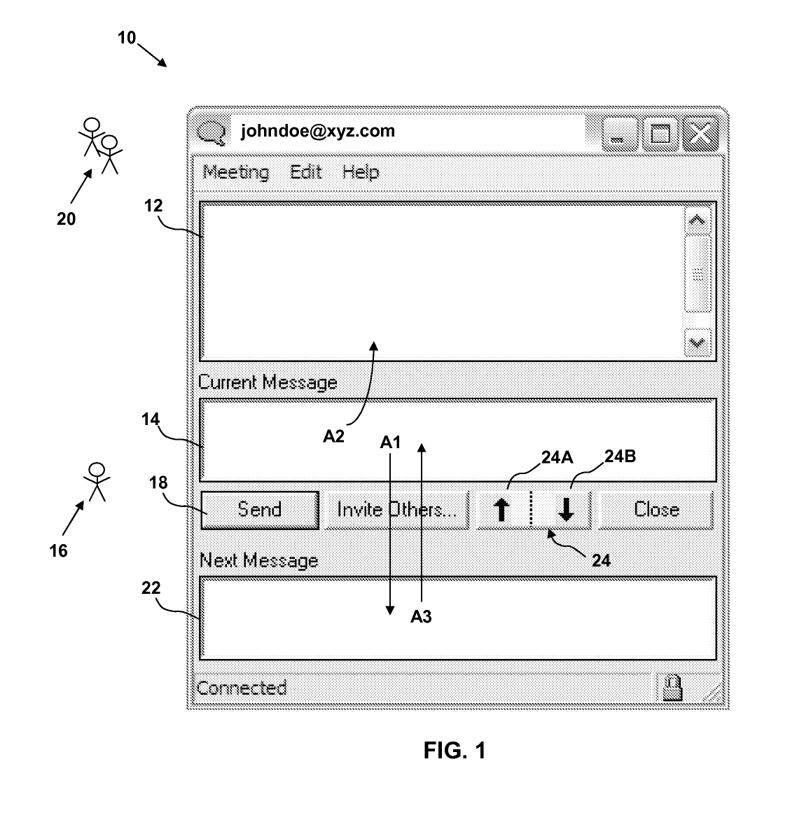

FIG. 1 depicts an illustrative instant messaging (IM) interface 10 with multiple windows in accordance with an embodiment of the present invention. The IM interface 10 includes a chat window 12 for displaying an ongoing chat between a plurality of IM users, a current message window 14 in which an IM user 16 can type a response for inclusion in the chat, and a Send button 18 for sending the response from the current message window 14 to the other IM users 20 involved in the chat. The sent response is also displayed in the chat window 12. Other buttons, such as an “Invite Others” button and a Close button, are also provided as part of the IM interface 10.

In addition to the current message window 14, the IM interface 10 of the present invention includes a next message window 22. During a chat, the IM user 16 can temporarily place (e.g., save) a response that is “in progress” in the current message window 14 into the next message window 22 in response to a move command, thus allowing the IM user 16 to prepare a new response in the current message window 14. To this extent, response data in the current message window 14 is cleared and sent to the next message window 22, where it remains available and viewable to the IM user 16.

The above process can be performed in response to a move command initiated via a move element in the IM interface 10. In an embodiment, the move element comprises a Move button 24. When the Move button 24 is actuated by the IM user 16, the response data in the current message window 14 is cleared and sent (A1) to the next message window 22. After the IM user 16 has sent (A2) a new response typed into the current message window 14 to the other IM users 20 involved in the chat (e.g., using the Send button 18, hotkey, menu selection, etc.), the IM user 16 can again actuate the Move button 24 to send (A3) the response data that was previously sent to the next message window 22 back to the current message window 14, where it can be further edited by the IM user 16 and/or sent to the other IM users 20 in the chat. The response data can be cleared from the next response window 22 after it is sent back to the current message window 14.

The response data sent to the next message window 22 can be held in the next message window 22 until needed by the IM user 16. Further, the IM user 16 can edit the response data directly in the next message window 22, before moving the data back into the current message window 14.

The IM user 16 can actuate the Move button 24 at any time to move the response data that was previously sent to the next message window 22 back to the current message window 14. In this case, response data, if any, in the current message window 14 is deleted and replaced by the response data sent back to the current message window 14 from the next response window 22. The IM user 16 can be provided with a “Yes/No delete” dialog box and/or the like before the response data in the current message window 14 is actually deleted.

The functionality of the Move button 24 can also be provided using a pair of separate buttons; a first Move button 24A for clearing the response data in the current message window 14 and sending it to the next message window 22; and a second Move button 24B for moving the response data previously sent to the next message window 22 back to the current message window 14. A vertical dotted line in the Move button 24 is used to represent the use of separate Move buttons 24A, 24B. It should also be noted that other techniques, such as the use of hotkey(s), menu selection(s), and/or the like, can be used to initiate the moving processes between the current message window 14 and the next message window 22.

In another embodiment, the response data in the next message window 22 can be automatically sent to the current message window 14 in response to the sending of a response typed into the current response window 14. Once there, the response data can be further edited by the IM user 16 and/or sent to the other IM users 20 in the chat. Alternatively, the response data (or an edited version thereof) can again be sent to the next message window 22 in response to an actuation of the Move button 24.

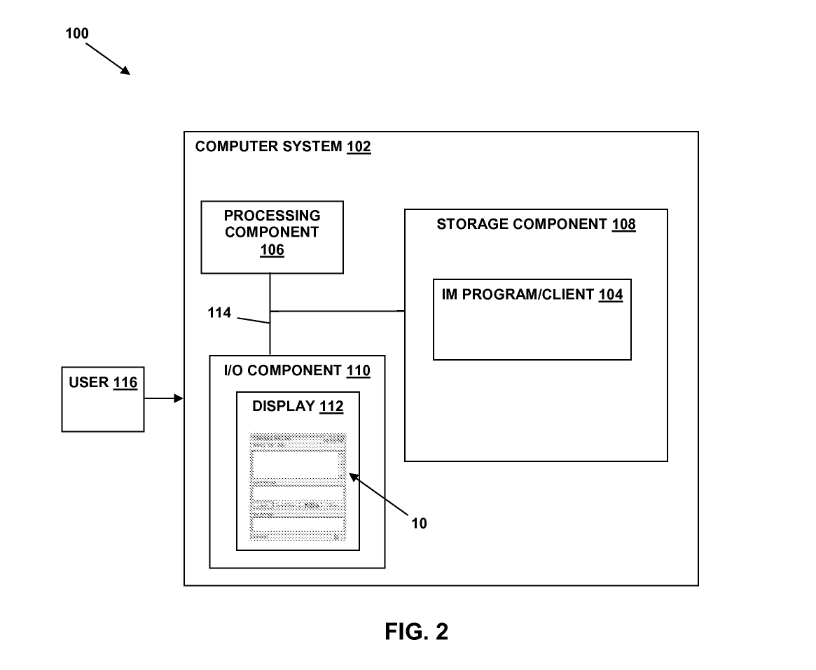

FIG. 2 shows an illustrative environment 100 for providing an instant messaging (IM) interface 10 with multiple windows in accordance with an embodiment(s) of the present invention. To this extent, environment 100 includes a computer system 102 that can perform the processes described herein. For example, the computer system 102 can be configured to include an IM program/client 104 that provides an IM interface 10 in accordance with the present invention.

The computer system 102 is shown including a processing component 106 (e.g., one or more processors), a storage component 108 (e.g., a storage hierarchy), an input/output (I/O) component 110 (e.g., one or more I/O interfaces and/or devices (e.g., a display 112), and a communications pathway 114. In general, the processing component 106 executes program code, such as the IM program/client 104, which is at least partially stored in storage component 108. While executing program code, the processing component 106 can read and/or write data to/from the storage component 108 and/or the I/O component 110. The communication pathway 114 provides a communications link between each of the components in computer system 102. The I/O component 110 can comprise one or more human I/O devices, which enable a human user 116 to interact with the computer system 102, and/or one or more communications devices to enable other computer system(s) to communicate with the computer system 102 using any type of communications link.

The computer system 102 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the IM program/client 104 can be embodied as any combination of system software and/or application software.

It is further understood that aspects of the invention further provide various alternative embodiments. For example, in one embodiment, the invention provides a computer program stored on at least one computer-readable medium, which when executed, enables a computer system to perform the processes described above. To this extent, the computer-readable medium can include program code, such as the IM program/client 104, which implement some or all of the process described herein. It is understood that the term “computer-readable medium” comprises one or more of any type of tangible medium of expression capable of embodying a copy of the program code (e.g., a physical embodiment). For example, the computer-readable medium can comprise: one or more portable storage articles of manufacture; one or more memory/storage components of a computing device; a modulated data signal having one or more of its characteristics set and/or changed in such a manner as to encode information in the signal; paper; and/or the like.

In another embodiment, a computer system, such as the computer system 102, can be obtained (e.g., provided, created, maintained, made available, etc.) and one or more programs/systems for performing the process described herein can be obtained (e.g., provided, created, purchased, used, modified, etc.) and deployed to the computer system. To this extent, the deployment can comprise one or more of: (1) installing program code on a computing device from a computer-readable medium; (2) adding one or more computing devices to the computer system; and (3) incorporating and/or modifying the computer system to enable it to perform the process described herein.

Aspects of the invention can be also implemented as part of a business method that performs the process described herein on a subscription, advertising, and/or fee basis. That is, a service provider could offer to provide some/all of the components/processes needed to provide an IM program/client 104, as described herein. In this case, the service provider can manage (e.g., create, maintain, support, etc.) some or all of the environment 100, such as the computer system 102, that performs the process described herein for one or more customers. In return, the service provider can receive payment from the customer(s) under a subscription and/or fee agreement, receive payment from the sale of advertising to one or more third parties, and/or the like.

The foregoing description of the embodiments of this invention has been presented for purposes of illustration and description. It is not intended to be exhaustive or to limit the invention to the precise form disclosed, and many modifications and variations are possible.

What is claimed is:

1. An instant messaging (IM) interface, comprising:
a chat window for displaying a chat between a plurality of IM users;
a current response window for displaying response data for inclusion in the chat;
a next response window; and
a move element for:
clearing the response data displayed in the current response window and sending the response data to, and displaying the response data in, the next response window; and
sending the response data displayed in the next response window back to the current response window.

2. The instant messaging interface of claim 1, wherein the move element comprises at least one move button.

3. The instant messaging interface of claim 1, wherein a first actuation of move element clears the response data in the current response window and sends the response data to next response window, and wherein a next actuation of the move element sends the response data from the next response window back to the current response window.

4. The instant messaging interface of claim 1, wherein the response data displayed in the next response window is automatically sent back to the current response window in response to a sending of response data from the current response window for inclusion in the chat.

5. The instant messaging interface of claim 4, further including:
a send button for sending the response data from the current response window for inclusion in the chat.

6. The instant messaging interface of claim 1, wherein the response data can be edited in at least one of the current response window or the next response window.

7. A method for instant messaging, comprising:
providing an instant messaging (IM) interface comprising a chat window for displaying a chat between a plurality of IM users, a current response window for displaying response data for inclusion in the chat, a next response window, and a move element;
actuating the move element to clear the response data displayed in the current response window and to send the response data to, and display the response data in, the next response window; and
actuating the move element to send the response data displayed in the next response window back to the current response window.

8. The method of claim 7, wherein a first actuation of move element clears the response data in the current response window and sends the response data to next response window, and wherein a next actuation of the move element sends the response data from the next response window back to the current response window.

9. The method of claim 7, wherein the response data displayed in the next response window is automatically sent back to the current response window in response to a sending of response data from the current response window for inclusion in the chat.

10. The method of claim 7, further comprising:
editing the response data in at least one of the current response window or the next response window.
